(19) United States
(12) Patent Application Publication
(10) Pub. No.: US 2022/0138566 A1
(43) Pub. Date: May 5, 2022

(54) LEARNING SYSTEM, LEARNING METHOD AND PROGRAM

(71) Applicant: Rakuten Group, Inc., Tokyo (JP)

(72) Inventor: Cheng-Chou LAN, Setagaya-ku, Tokyo (JP)

(73) Assignee: Rakuten Group, Inc., Tokyo (JP)

(21) Appl. No.: 17/414,596

(22) PCT Filed: Aug. 29, 2019
(86) PCT No.: PCT/JP2019/033910

§ 371 Date: Jun. 16, 2021

(51) Int. Cl. G06N 3/08

(52) U.S. Cl. CPC G06N 3/08

(57) ABSTRACT

A learning system comprising at least one processor configured to: obtain training data to be learned by a learning model; and repeatedly execute a learning process of the learning model based on the training data, wherein the at least one processor quantizes a parameter of a part of layers of the learning model and executes the learning process, and then quantizes parameters of other layers of the learning model and executes the learning process.

### TECHNICAL FIELD

The one or more embodiments of the present invention relates to a learning system, a learning method, and a program.

### BACKGROUND ART

There are known techniques for repeatedly executing a learning process of a learning model based on training data. For example, Patent Literature 1 describes the learning system in which the learning process is repeated a number of times called the number of epochs based on the training data.

### CITATION LIST

### Patent Literature

Patent Literature 1: JP2019-074947A

### SUMMARY OF INVENTION

### Technical Problem

In the technique as described above, as the number of layers of the learning model increases, the number of parameters of the entire learning model also increases, and the data size of the learning model increases accordingly. In this regard, it is conceivable to quantize the parameters to reduce the amount of information of individual parameters and to reduce the data size. However, according to the confidential study conducted by the inventors of the one or more embodiments of the present invention, the accuracy of the learning model was greatly reduced if all parameters were quantized at once to execute the learning process.

One or more embodiments of the present invention have been conceived in view of the above, and an object thereof is to provide a learning system, a learning method, and a program capable of reducing a data size of a learning model while preventing accuracy degradation of the learning model.

### Solution to Problem

In order to solve the above described issues, a learning system according to one aspect of the present invention includes obtaining means for obtaining training data to be learned by a learning model, and training means for repeatedly executing a learning process of the learning model based on the training data, wherein the training means quantizes a parameter of a part of layers of the learning model and executes the learning process, and then quantizes parameters of other layers of the learning model and executes the learning process.

A learning method according to one aspect of the present invention includes an obtaining step of obtaining training data to be learned by a learning model, and a training step of repeatedly executing a learning process of the learning model based on the training data, wherein the training step quantizes a parameter of a part of layers of the learning model and executes the learning process, and then quantizes parameters of other layers of the learning model and executes the learning process.

A program according to one aspect of the present invention causes a computer to function as obtaining means for obtaining training data to be learned by a learning model, and training means for repeatedly executing a learning process of the learning model based on the training data, wherein the training means quantizes a parameter of a part of layers of the learning model and executes the learning process, and then quantizes parameters of other layers of the learning model and executes the learning process.

According to one aspect of the present invention, the training means repeatedly executes the learning process until parameters of all of the layers of the learning model are quantized.

According to one aspect of the present invention, the training means quantizes the layers of the learning models one by one.

According to one aspect of the present invention, the training means selects layers to be quantized one after another in a predetermined order from the learning model.

According to one aspect of the present invention, the training means randomly selects layers to be quantized one after another from the learning models.

According to one aspect of the present invention, the training means quantizes the parameter of the part of the layers and repeats the learning process a predetermined number of times, and then quantizes the parameters of the other layers and repeats the learning process a predetermined number of times.

According to one aspect of the present invention, the training means selects layers to be quantized one after another based on each of a plurality of orders and creates a plurality of learning models, and the learning system further comprises selecting means for selecting at least one of the plurality of learning models based on accuracy of each learning model.

According to one aspect of the present invention, the learning system further includes other model training means for executing a learning process of other learning models based on an order corresponding to the learning model selected by the selecting means.

According to one aspect of the present invention, a parameter of each layer includes a weighting factor, and the training means quantizes a weighting factor of the part of the layers and executes the learning process, and then quantizes weighting factors of other layers and executes the learning process.

According to one aspect of the present invention, the training means binarizes a parameter of a part of the learning model and executes the learning process, and then binarizes parameters of other layers of the learning model and executes the learning process.

### Effects of the Invention

According to the present invention, it is possible to reduce the data size of the learning model while preventing the accuracy degradation of the learning model.

### BRIEF DESCRIPTION OF THE DRAWINGS

FIG. 1 is a diagram illustrating an overall configuration of a learning system;

FIG. 2 is a diagram illustrating a learning method of a typical learning model;

FIG. 3 is a diagram illustrating an example of a learning process in which a weighting factor is quantized;

FIG. 4 is a diagram illustrating an example of a learning process for quantizing layers one by one;

FIG. 5 is a diagram illustrating an example of a learning process for quantizing layers from the last layer in order;

FIG. 6 is a diagram illustrating accuracy of the learning model;

FIG. 7 is a functional block diagram showing an example of functions implemented in the learning system;

FIG. 8 is a diagram showing an example of data storage of a training data set;

FIG. 9 is a flow chart showing an example of processing executed in the learning system; and

FIG. 10 is a functional block diagram of a variation.

### DESCRIPTION OF EMBODIMENTS

### [1. Overall Configuration of Learning System]

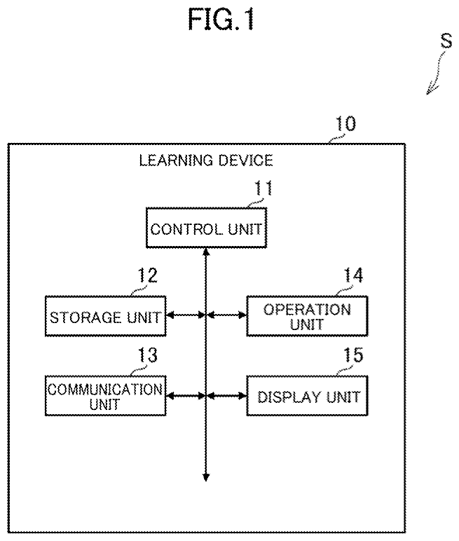

An embodiment of a learning system according to the one or more embodiments of the present invention will be described below. FIG. 1 is a diagram illustrating an overall configuration of the learning system. As shown in FIG. 1, the learning system S includes a learning device 10. The learning system S may include a plurality of computers capable of communicating with each other.

The learning device 10 is a computer that executes the processing described in this embodiment. For example, the learning device 10 may be a personal computer, a server computer, a portable information terminal (including a tablet computer), or a mobile phone (including a smart phone). The learning device 10 includes a control unit 11, a storage unit 12, a communication unit 13, an operation unit 14, and a display unit 15.

The control unit 11 includes at least one processor. The control unit 11 executes processing in accordance with programs and data stored in the storage unit 12. The storage unit 12 includes a main storage unit and an auxiliary storage unit. For example, the main storage unit is a volatile memory such as RAM, and the auxiliary storage unit is a nonvolatile memory such as ROM, EEPROM, flash memory, and hard disk. The communication unit 13 is a communication interface for wired or wireless communication and performs data communication via a network such as the Internet.

The operation unit 14 is an input device, and is, for example, a pointing device such as a touch panel and a mouse, a keyboard, or a button. The operation unit 14 transmits an operation of the user to the control unit 11. The display unit 15 is, for example, a liquid crystal display unit or an organic EL display unit. The display unit 15 displays images according to an instruction from the control unit 11.

The programs and data described as being stored in storage unit 12 may be supplied via networks. Further, the hardware configuration of each computer described above is not limited to the above example, and various types of hardware can be applied. For example, a reading unit (e.g., an optical disk drive or a memory card slot) for reading a computer-readable information storage medium or an input/output unit (e.g., a USB port) for inputting/outputting data to/from an external device may be included. For example, a program or data stored in the information storage medium may be supplied to each computer through the reading unit or the input/output unit.

### [2. Outline of Learning System]

The learning system S of this embodiment executes the learning process of a learning model based on training data.

The training data is data to be learned by the learning model. The training data may also be referred to as learning data or teacher data. For example, the training data is a pair of input (questions) to the learning model and output (answers) of the learning model. For example, in the case of a classifier, the training data is data including pairs of data having the same format as the input data entered in the learning model and a label indicating the classification of the input data.

For example, if the input data is an image or video, the training data is a pair of an image or video and a label indicating a classification of an object (subject or object drawn in CG) shown in the image or the video. Also, for example, if the input data is text or a document, the training data is a pair of the text or the document and a label indicating a classification of the content described therein. Further, for example, if the input data is sound, the training data is a pair of the sound and a label indicating a classification of the sound or a speaker.

In the machine learning, the learning process is executed by using a plurality of pieces of training data. As such, in this embodiment, a group of a plurality of pieces of training data is described as a training data set, and one piece of data included in the training data set is described as training data. In this embodiment, a part described as training data means the pair described above, and the training data set means a group of pairs.

The learning model is a model of supervised learning. The learning model can perform any processing, for example, image recognition, character recognition, speech recognition, recognition of human behavior patterns, or recognition of natural phenomena. Various known techniques can be applied to the machine learning, for example, DNN (Deep Neural Network), CNN (Convolutional Neural Network), ResNet (Residual Network, and RNN (Recurrent Neural Network) can be used.

The learning model includes a plurality of layers, and a parameter is set in each layer. For example, the layers may include a layer called by a name such as Affine, ReLU, Sigmoid, Tanh or Softmax. The learning model may include any number of layers, for example, about several layers or ten or more layers. Further, a plurality of parameters may be set in each layer.

The learning process is a process of training the learning model to learn training data. In other words, the learning process is a process of adjusting the parameters of the learning model so as to obtain the relationship between the inputs and the outputs of the training data. The processing used in known machine learning can be applied to the learning process, and, for example, the learning process of DNN, CNN, ResNet, or RNN can be used. The learning process is executed by a predetermined learning algorithm (learning program).

In this embodiment, the processing of the learning system S will be described by taking an example of DNN for recognizing images as a learning model. When an unknown image is entered into a trained learning model, the learning model calculates a feature amount of the image and outputs a label indicating a type of an object in the image based on the feature amount. Training data to be learned in such a learning model is a pair of an image and a label of an object shown in the image.

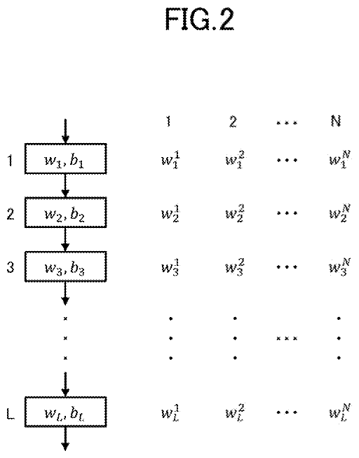

FIG. 2 is a diagram illustrating a learning method of a typical learning model. As shown in FIG. 2, the learning model includes a plurality of layers, and a parameter is set in each layer. In this embodiment, the number of layers of the learning model is L (L: natural number). The L layers are arranged in a predetermined order. In this embodiment, a parameter of i-th layer (i: a natural number between 1 and L) is described as p As shown in FIG. 2, a parameter pᵢ of each layer includes a weighting factor wᵢ and a bias bᵢ.

According to the typical learning method of DNN, the learning process is repeated by a number of times called the number of epochs based on the same training data. In the example of FIG. 2, the number of epochs is set to N (N: natural number), and in each of the N learning processes, the weighting factor wᵢ of each layer is adjusted. The learning process is repeated so as to gradually adjust the weighting factor wᵢ for each layer so that the input-output relationship indicated by the training data is obtained.

For example, a weighting factor wᵢ of an initial value of each layer is adjusted by the first learning process. In FIG. 2, the weighting factor adjusted by the first learning process is described as wᵢ¹. When the first learning process is completed, the second learning process is executed. The second learning process adjusts the weighting factor wᵢ¹ of each layer. In FIG. 2, the weighting factor adjusted by the second learning process is described as wᵢ². Thereafter, the learning process is repeated N times in the same manner. In FIG. 2, the weighting factor adjusted by the N-th learning process is described as wᵢ^{N}. wᵢ^{N} is the weighting factor wᵢ to be finally set in the learning model.

As described in the background art, as the number of layers in the learning model increases, the number of parameters pᵢ also increases, and thus the data size of the learning model increases. As such, the learning system S reduces the data size by quantizing the weighting factor wᵢ. In this embodiment, an example of a case will be described in which a weighting factor wᵢ, which is generally represented as a floating-point number, is binarized to compress the amount of information in the weighting factor wᵢ and reduce the data size of the learning model.

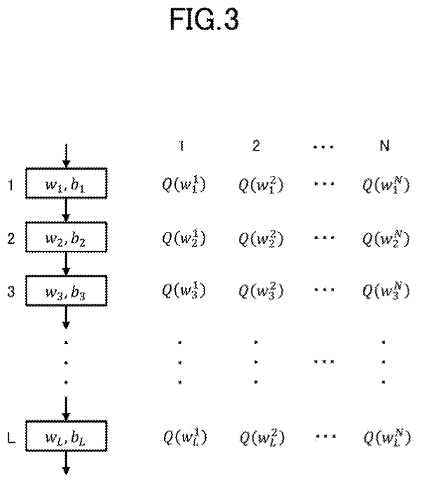

FIG. 3 is a diagram illustrating an example of the learning process in which the weighting factor wᵢ is quantized. Q(x) shown in FIG. 3 is a function for quantizing a variable x, for example, “−1” when “x≤0” and “1” when “x>0”. The quantization is not limited to binarization, and may be performed in two or more stages. For example, Q(x) may be a function that performs three-step quantization of “−1,” “0,” and “1” or a function that performs quantization between “−2ⁿ” and “2ⁿ” (n: natural number). Any number of steps or a threshold value for quantization may be used.

In the example shown in FIG. 3, a weighting factor wᵢ of an initial value of each layer is adjusted and quantized by the first learning process. In FIG. 3, the weighting factor adjusted by the first learning process is described as Q (wᵢ^{l}). In the example of FIG. 3, the weighting factors wᵢ of all the layers are quantized by the first learning process and represented by “−1” or “1”.

When the first learning process is completed, the second learning process is executed. The quantized weighting factor Q (wᵢ²) is obtained by the second learning process. Thereafter, the learning process is repeated N times in the same manner. In FIG. 2, the weighting factor quantized by the N-th learning process is described as Q (wᵢ^{N}). Q(wᵢ^{N}) is the weighting factor wᵢ that is finally set in the learning model.

As described above, when the weighting factor wᵢ of each layer is quantized, the amount of information can be compressed compared with a floating-point number, for example, and thus the data size of the learning model can be reduced. However, according to the inventor's own research, it was discovered that quantizing all layers at once greatly reduces the accuracy of the learning model. As such, the learning system S of this embodiment quantizes the layers one by one, thereby preventing the accuracy degradation of the learning model.

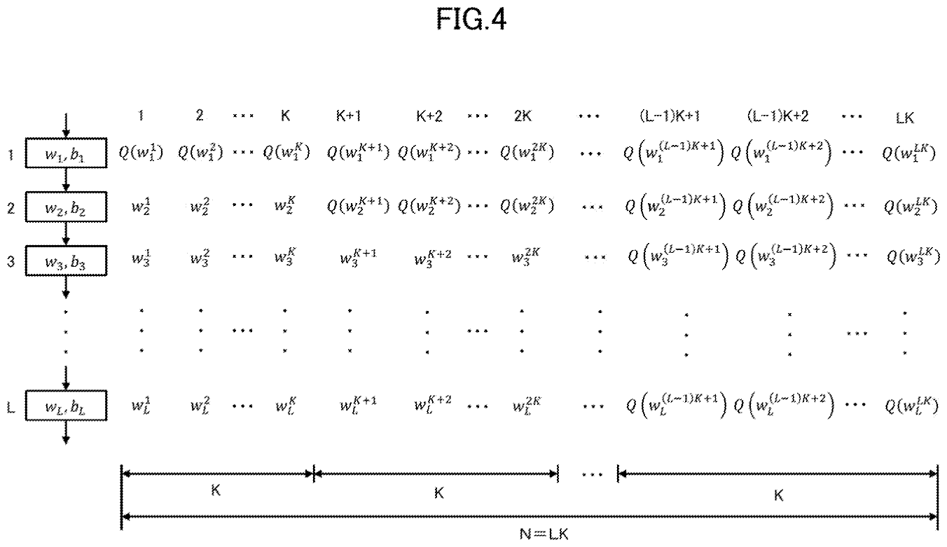

FIG. 4 is a diagram illustrating an example of the learning process for quantizing the layers one by one. As shown in FIG. 4, the first learning process is executed in which only the weighting factor wᵢ of the first layer is quantized. As such, the weighting factors w₂ to w_{L} of the second and subsequent layers are not quantized and remain floating-point numbers. Accordingly, by the first learning process, the weighting factor of the first layer becomes Q(w₁¹) and the weighting factors of the second and subsequent layers become w₂¹ to w_{L}¹.

When the first learning process is completed, the second learning process is executed. In the second learning process as well, only the weighting factor w₁ of the first layer is quantized. As such, by the second learning process, the weighting factor of the first layer becomes Q(w₁²) and the weighting factors of the second and subsequent layers become w₂² to w_{L}². Subsequently, the learning process in which only the weighting factor w₁ of the first layer is quantized is repeated K times (K: natural number). By the K-th learning process, the weighting factor of the first layer becomes Q(w₁^{K}), and the weighting factors of the second and subsequent layers becomes w₂^{K} to W_{L}^{K}.

When the K-th learning process is completed, the K+1-th learning process is executed, and the weighting factor w₂ of the second layer is quantized. The weighting factor w₁ of the first layer has already been quantized, and is also quantized in the K+1-th and subsequent learning processes. On the other hand, the weighting factors w₃ to w_{L} of the third and subsequent layers remain floating-point numbers without being quantized. As such, by the K+1-th learning process, the weighting factors of the first and second layers become Q (w₁^{K+1}) and Q(w₂^{K+1}), respectively, and the weighting factors of the third and subsequent layers become w₃^{K+1} to w_{L}^{K+1}.

When the K+1-th learning process is completed, the K+2-th learning process is executed. In the K+2-th learning process as well, only the weighting factors w₁, w₂ of the first and second layers are quantized. As such, by the K+2-th learning process, the weighting factors of the first and second layers become Q(w₁^{K+}2) and Q(s₂^{K+2}), respectively, and the weighting factors of the third and subsequent layers become w₃^{K+2} to w_{L}^{K+2}. Subsequently, the learning process in which only the weighting factors w₁,w₂ of the first and second layers are quantized is repeated K times. By the K+2-th learning process, the weighting factors of the first and second layers become Q(w₁^{2K}) and Q(w₂^{2K}), respectively, and the weighting factors of the third and subsequent layers are w₃^{2K} to w_{L}^{2K}.

Thereafter, the learning process is executed in the same manner in which the third and subsequent layers are sequentially quantized one by one. In the example of FIG. 4, the number of layers is L and each has epoch number K, and thus the total number of learning processes is LK, and eventually the weighting factors wᵢ of all the layers are quantized. The weighting factors Q(wᵢ^{LK}) of the respective layers quantized by the LK-th learning process are weighting factors finally set in the learning model.

In FIG. 4, the layers are quantized in the forward direction (ascending order) in the order of arrangement from the first layer to the L-th layer, although quantization of each layer may be performed in any order. For example, the layers may be quantized in the reverse direction (descending order) in the order of arrangement from the first layer to the L-th layer.

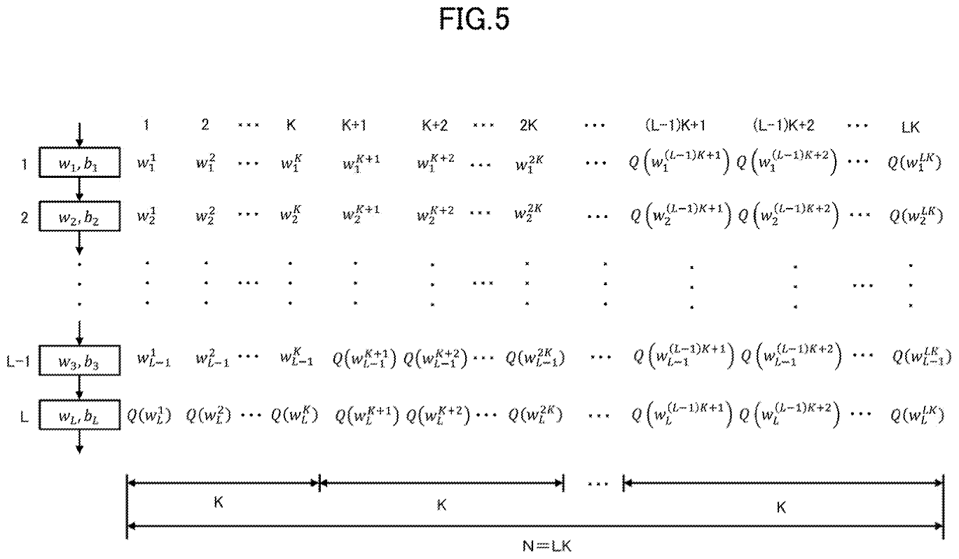

FIG. 5 is a diagram illustrating an example of a learning process for quantizing the layers from the last layer in order. As shown in FIG. 5, the first learning process is executed in which only the weighting factor w_{L} of the L-th layer is quantized. As such, the weighting factors w₁ to w_{L-1} of the first to L−1-th layers remain floating-point numbers without being quantized. By the first learning process, the weighting factor of the L-th layer becomes Q(w_{L}¹), and the weighting factors of the first to L−1-th layer become w₁¹ to wL−1¹.

When the first learning process is completed, the second learning process is executed. In the second learning process as well, only the weighting factor w_{L} of the L-th layer is quantized. As such, the weighting factor of the L-th layer becomes Q(w_{L}²) by the second learning process, and the weighting factors of the first to L−1-th layers become w₁² to w_{L-1}². Subsequently, the learning process in which only the weighting factor w_{L} of the L-th layer is quantized is repeated K times (K is a natural number). After the Kth learning process, the weighting factor of the Lth layer becomes Q(w_{L}^{K}), and the weighting factors of the first to L−1-th layers become w₁^{K} to w_{L-1}^{K}.

When the K-th learning process is completed, the K+1-th learning process is executed, and the weighting factor w_{L-1} of the L−1-th layer is quantized. The weighting factor w_{L} of the L-th layer has already been quantized and is also quantized in the K+1 and subsequent learning processes. On the other hand, the weighting factors w₁ to w_{L-2} of the first to L−2-th layers remain floating-point numbers without being quantized. As such, by the K+1-th learning process, the weighting factors of the L−1-th and L-th layers become Q(w_{L-1}^{K+1}) and Q(w_{L}^{K+1}), respectively, and the weighting factors of the first to L−2-th layers become w₁^{K+1} to w_{L-2}^{K+1}.

When the K+1-th learning process is completed, the K+2-th learning process is executed. In the K+2-th learning process as well, only the weighting factors w_{L-1}, w_{L} of the L−1-th and L-th layers are quantized. As such, by the K+2-th learning process, the weighting factors of the L−1-th and L-th layers become Q(w_{L-1}^{K+2}) and Q(w_{L}^{K+2}), respectively, and the weighting factors of the first to L−2-th layers become w₁^{K+2} to w_{L-2}^{K+2}. Subsequently, the learning process in which only the weighting factors w_{L-1},w_{L} of the L−1-th and L-th layers are quantized is repeated K times. By the 2K-th learning process, the weighting factors of the L−1-th and L-th layers become Q(w_{L-1}^{2K}) and Q(w_{L}^{2K}),respectively, and the weighting factors of the first to L-2-th layers become w₁^{2K} to w_{L-2}^{2K}.

Thereafter, the learning process is performed in the same manner in which the layers are quantized one by one in the reverse direction of the layer arrangement. In this manner, the layers may be quantized in the reverse direction instead of the forward direction of the layer arrangement. Further, the layers may be quantized in an order other than the forward or reverse direction of the layer arrangement. For example, the layers may be quantized in an order such as “the third layer→the fifth layer→the third layer→the second layer . . . ”

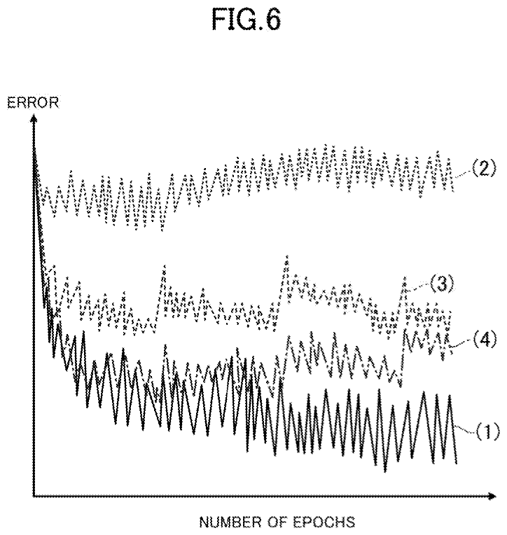

FIG. 6 is a diagram illustrating accuracy of the learning model. In the example of FIG. 6, an error rate (incorrect answer rate) for training data is used as the accuracy. FIG. 6 shows four learning models: (1) a learning model that does not quantize the weighting factor wᵢ (the learning model of FIG. 2); (2) a learning model that quantizes all layers at once (the learning model of FIG. 3); (3) a learning model that quantizes layers one by one in the forward direction (the learning model of FIG. 4); and (4) a learning model that quantizes layers one by one in the reverse direction (the learning model of FIG. 5).

As shown in FIG. 6, the learning model (1) has the highest accuracy because the weighting factor wᵢ is not quantized and shown in detail. However, as described above, the learning model of (1) has the largest data size because the weighting factor wᵢ must be expressed as a floating point number, for example. On the other hand, in the learning model of (2), the data size is reduced because the weighting factor wᵢ is quantized, but the accuracy of the learning model is lowest because all the layers are quantized at once.

The learning model (3) and the learning model (4) quantize the weighting factors wᵢ. As such, the data size is small and is the same as or substantially the same as that of the learning model (2). However, it is possible to reduce the accuracy degradation of the learning model by not quantizing all layers at once but gradually quantizing each layer. Reduction of data size by quantization and accuracy of a learning model have a trade-off relationship. In this embodiment, each layer is gradually quantized, which serves to minimize the accuracy degradation of the learning model.

In the example of FIG. 6, the accuracy of the learning model (4) is higher than that of the learning model (3), but depending on the condition such as the content of the training data and the number of layers, the accuracy of the learning model (3) may be higher than that of the learning model of (4). As another example, compared to the learning model that quantizes the layers in the forward or reverse direction, the learning model that quantize the layers in other orders may have higher accuracy. However, regardless of the order, the learning model that quantizes the layers one by one has higher accuracy than the learning model (2) that quantizes all the layers at once.

As described above, the learning system S of the present embodiment executes the learning process by not quantizing all the layers at once but quantizing the layers one by one. This can reduce the data size of the learning model while minimizing the accuracy degradation of the learning model. In the following, the learning system S will be described in detail. In the following description, reference numerals of parameters and weighting factors are omitted when it is not necessary to refer to the drawings.

### [3. Functions Implemented in Learning System]

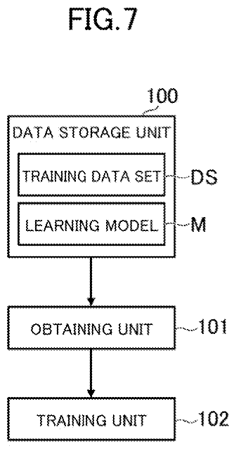

FIG. 7 is a functional block diagram showing an example of functions implemented in the learning system S. As shown in FIG. 7, a data storage unit 100, an obtaining unit 101, and a training unit 102 are implemented in the learning system S. In this embodiment, a case will be described in which these functions are implemented by the learning device 10.

### [Data Storage Unit]

The data storage unit 100 is implemented mainly by the storage unit 12. The data storage unit 100 stores the data required for performing the processing described in this embodiment. Here, a training data set DS and a learning model M will be described as an example of the data stored in the data storage unit 100.

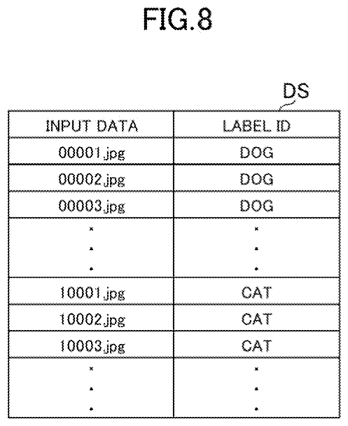

FIG. 8 is a diagram showing an example of data storage of the training data set DS. As illustrated in FIG. 8, the training data set DS includes a plurality of pieces of training data, which are pairs of input data and labels. In FIG. 8, the training data set DS is shown in a table format, in which each record corresponds to training data. In FIG. 8, the labels are indicated by letters such as “dog” and “cat”, but may be indicated by symbols or numerical values for identifying the labels. The input data corresponds to the question for the learning model M and the label corresponds to the answer.

The data storage unit 100 stores, for example, programs and parameters of the learning model M. Here, a case will be described in which the learning model M that has been trained by the training data set DS (i.e., the parameter has been adjusted) is stored in the data storage unit 100, although the learning model M that has not been trained (i.e., the parameter has not been adjusted) may be stored in the data storage unit 100. In the following description, the reference symbol of the learning model M is omitted.

The data stored in the data storage unit 100 is not limited to the examples described above. For example, the data storage unit 100 may store algorithms (programs) for the learning process. For example, the data storage unit 100 may store setting information such as the order of layers to be quantized and the number of epochs.

### [Obtaining Unit]

The obtaining unit 101 is mainly implemented by the control unit 11. The obtaining unit 101 obtains the training data to be learned by the learning model. In this embodiment, the training data set DS is stored in the data storage unit 100, and thus the obtaining unit 101 obtains at least one piece of training data from the training data set DS stored in the data storage unit 100. The obtaining unit 101 may obtain any number of pieces of training data and may obtain the entire or a part of the training data set DS. For example, the obtaining unit 101 may obtain about ten to several tens of pieces of training data, or about one hundred to several thousand or more pieces of training data. In a case where the training data set DS is stored in a computer or information storage medium other than the learning device 10, the obtaining unit 101 may obtain the training data from the other computer or the information storage medium.

### [Training Unit]

The training unit 102 is mainly implemented by the control unit 11. The training unit 102 repeatedly executes a learning process of the learning model based on the training data obtained by the obtaining unit 101. As described above, a known method can be applied to the learning process, and in this embodiment, the learning model of the DNN is taken as an example, and thus the training unit 102 may repeatedly execute the learning process based on the learning algorithms used in the DNN. The training unit 102 adjusts the parameters of the learning model so as to obtain the relationship between inputs and outputs indicated by the training data.

The number of repetitions (the number of epochs) of the learning process may be a predetermined number, for example, several to 100 times or more. Assume that the number of repetitions is stored in the data storage unit 100. The number of repetitions may be a fixed value or changed by the user's operation. For example, the training unit 102 repeats the learning process by the number of repetitions based on the same training data. Different training data may be used in the respective learning processes. For example, the training data that is not used in the first learning process may be used in the second learning process.

The training unit 102 performs the learning process by quantizing parameters of a part of the layers of the learning model, and then performs the learning process by quantizing parameters of the other layers of the learning model. That is, the training unit 102 executes the learning process by quantizing the parameters of only a part of the layers and not quantizing the other layers, instead of quantizing the parameters of all the layers at a time. In this embodiment, a case will be described in which the parameters that are not quantized are also adjusted, although the parameters that are not quantized may not be adjusted. Thereafter, the training unit 102 quantizes the parameters of the other layers that are not quantized and executes the learning process. In this embodiment, a case will be described in which the quantized parameters are also adjusted, although the quantized parameters may be excluded from the subsequent adjustments.

A part of the layers is one or more and less than L layers selected to be quantized. In this embodiment, a case will be described in which a part of the layers is one layer because the layers are quantized one by one, although a part of the layers may be two or more layers. It is sufficient if all of the L layers are not be quantized at a time, and thus, for example, the layers may be quantized two by two, or three by three. Alternatively, the number of layers to be quantized may be varied, for example, one layer is quantized and then another plurality of layers are quantized. The other layer is a layer other than a part of the layers of the learning model. The other layer may be all layers other than a part of the layers, or some of the layers other than a part of the layers.

In this embodiment, the layers are gradually quantized and eventually all the layers are quantized, and thus the training unit 102 repeatedly executes the learning process until the parameters of all the layers of the learning model are quantized. For example, the training unit 102 selects a layer to be quantized from the layers that have not yet been quantized, and quantizes the parameter of the selected layer and executes the learning process. The training unit 102 repeats selecting a layer to be quantized and executing the learning process until all the layers are quantized. The training unit 102 terminates the learning process when the parameters of all the layers are quantized and determines the parameters of the learning model. The determined parameters are not floating-point numbers, for example, but quantized values.

In this embodiment, the training unit 102 quantizes the layers of the learning model one by one. The training unit 102 selects one of the layers that have not yet been quantized, and quantizes a parameter of the selected layer and executes the learning process. The training unit 102 selects the layers to be quantized one by one and gradually quantizes the L layers.

The order of quantizing the layers may be defined in the learning algorithm. In this embodiment, the order of quantizing the layers is stored in the data storage unit 100 as a setting of the learning algorithm for successively selecting layers to be quantized in a predetermined order from the learning model. The training unit 102 repeatedly selects a layer to be quantized and executes the learning process based on the predetermined order.

For example, as shown in FIG. 3, when the layers are quantized in the forward direction from the first layer to the L-th layer (in ascending order of the layer arrangement), the training unit 102 selects the first layer as a layer to be quantized, and executes the learning process K times. That is, the training unit 102 quantizes only the parameter p₁ of the first layer, and executes learning process K times without quantizing the parameters p₂ to p_{L} of the second and subsequent layers. Next, the training unit 102 selects the second layer as a layer to be quantized, and executes learning processing K times. That is, the training unit 102 quantizes the first layer that has already been quantized and the second layer that has been selected this time, and executes the learning process K times without quantizing the parameters p₃ to p_{L} of the third and subsequent layers. Thereafter, the training unit 102 executes the learning process by selecting the layers one by one in the forward direction of the layer arrangement up to the Lth layer.

Further, for example, as shown in FIG. 4, when the layers are quantized in the reverse direction from the L-th layer to the first layer (in descending order of the layer arrangement), the training unit 102 selects the L-th layer as a layer to be quantized, and executes the learning process K times. That is, the training unit 102 quantizes only the parameter p_{L} of the L-th layer, and executes the learning process K times without quantizing the parameters p₁ to p_{L-1} of the first to L−1-th layers. Next, the training unit 102 selects the L−1-th layer as a layer to be quantized, and executes the learning process K times. That is, the training unit 102 quantizes the L-th layer that has already been quantized and the L−1-th layer that is selected this time, and executes the learning process K times without quantizing the parameters pi to p_{L-2} of the first to L−2-th layers. Thereafter, the training unit 102 selects the layers one by one in the reverse direction of the layer arrangement up to the first layer and executes the learning process.

The order of selecting the layers to be quantized may be any order, and is not limited to the forward direction or the reverse direction of the layer arrangement. For example, the layers may not have to be quantized in ascending or descending order, but may be quantized in an order such as “the third layer→the fifth layer→the third layer→the second layer . . . ” Further, for example, a layer to be quantized first is not limited to the first layer or the L-th layer, but an intermediate layer such as the third layer may be selected first. Similarly, a layer to be quantized last is not limited to the first layer or the L-th layer, but an intermediate layer such as the third layer may be quantized last.

The selection order of the layers to be quantized may not be predetermined, and the training unit 102 may randomly and sequentially select the layers to be quantized from the learning model. For example, the training unit 102 may generate a random number using a rand function, and determine the selection order of the layer to be quantized based on the random number. In this case, the training unit 102 sequentially selects the layers to be quantized based on the selection order determined by the random number, and executes the learning process. The training unit 102 may collectively determine the selection order of the L layers at a time, or may randomly determine a layer to be selected next each time a layer is selected.

In this embodiment, the training unit 102 quantizes the parameter of a part of the layers and repeats the learning process a predetermined number of times, and then quantizes the parameters of the other layers and repeats the learning process a predetermined number of times. In this embodiment, these numbers of times are both K, although the number of repetitions may be different from each other. For example, in the example of FIG. 4, the number of repetitions may be different for each layer such that the first layer is quantized and the learning process is repeated ten times, and then the second layer is quantized and the learning process is repeated eight times.

In this embodiment, a parameter of each layer includes a weighting factor, and the training unit 102 quantizes the weighting factors of a part of the layers and executes the learning process, and then quantizes the weighting factors of the other layers and executes the learning process. That is, in a parameter of each layer, a weighting factor is to be quantized. In this embodiment, the bias is not quantized, but the parameter to be quantized may be the bias. Further, for example, both the weighting factor and the bias may be quantized. Further, for example, if a parameter other than the weighting factor and the bias exist in each layer, such a parameter may be quantized.

In this embodiment, binarization is described as an example of quantization, and thus the training unit 102 binarizes the parameters of a part of the layers of the learning model and executes the learning process, and then binarizes the parameters of the other layers of the learning model and executes the learning process. The training unit 102 binarizes the parameters by comparing a parameter of each layer with a predetermined threshold value. In this embodiment, as an example of binarization, parameters are classified into binary values of −1 or 1, but binarization may be executed with other values such as 0 or 1. That is, the binarization may be executed such that the parameters are classified into any first and second values.

[4. Processing Executed in this Embodiment]

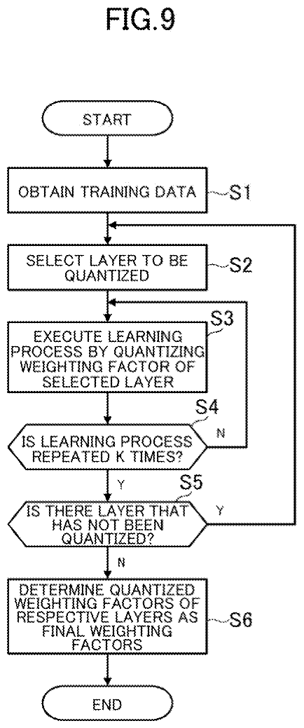

FIG. 9 is a flow chart showing an example of the processing executed in the learning system S. The processing shown in FIG. 9 is executed by the control unit 11 operating in accordance with programs stored in the storage unit 12. The processing described below is an example of the processing executed by the functional blocks shown in FIG. 7.

As shown in FIG. 9, the control unit 11 obtains the training data included in the training data set DS (S1). In S1, the control unit 11 refers to the training data set DS stored in the storage unit 12, and obtains any pieces of training data.

The control unit 11 selects a layer to be quantized from the layers that have not yet been quantized based on a predetermined order (S2). For example, as shown in FIG. 4, when the quantization is performed in the forward order of the layer arrangement, the control unit 11 first selects the first layer in S2. For example, as shown in FIG. 5, when the quantization is performed in the reverse order of the layer arrangement, the control unit 11 first selects the L-th layer in S2.

The control unit 11 quantizes the weighting factor of the selected layer and executes the learning process based on the training data obtained in S1 (S3). In S3, the control unit 11 adjusts the weighting factors of the respective layers so as to obtain the relationship between inputs and outputs indicated by the training data. The control unit 11 quantizes the weighting factors of the layers that have been selected to be quantized.

The control unit 11 determines whether the learning process, in which the weighting factors of the selected layers are quantized, is repeated K times (S4). In S4, the control unit 11 determines whether the processing of S3 has been executed K times after selecting the layer in S2. If it is not determined that the learning process is repeated K times (S4;N), the processing returns to S3, and the learning process is executed again. Subsequently, the processing of S3 is repeated until the learning process is executed K times.

On the other hand, if it is determined that the learning process has been repeated K times (S4;Y), the control unit 11 determines whether there is a layer that has not yet been quantized (S5). In this embodiment, K epochs are set for each of the L layers, and thus, in S5, the control unit 11 determines whether the learning process have been executed LK times in total.

If it is determined that there is a layer that has not yet been quantized (S5;Y), the process returns to S2, the next layer is selected, and the processing of S3 and S4 is executed. On the other hand, when it is not determined that there is a layer that has not yet been quantized (S5;N), the control unit 11 determines the quantized weighting factors of the respective layers as the final weighting factors of the learning model (S6), and the processing terminates. In S6, the control unit 11 stores the learning model, in which the latest quantized weighting factors are set in the respective layers, in the storage unit 12 and completes the learning process.

According to the learning system S described above, the parameter of a part of the learning model is quantized and the learning process is executed, and then the parameters of the other layers of the learning model are quantized and the learning process is executed. This can reduce the data size of the learning model while preventing the accuracy degradation of the learning model. For example, if all the layers of the learning model are quantized at once, the amount of information that the parameters have decreases at once, and thus the accuracy of the quantized parameters also decreases at once. By gradually quantizing the layers of the learning model so that the amount of the information gradually decreases, it is possible to prevent the amount of information from decreasing at once in this way. As such, it is possible to prevent the accuracy of the quantized parameters from decreasing at once, and to minimize the accuracy degradation of the learning model. In other words, while the learning process is executed by quantizing the parameter of a part of the learning model, the parameters of the other layers are not quantized but are accurately represented by floating-point numbers, for example. As such, compared to the case where the parameters of the other layers are also quantized, the values of the quantized parameters can be accurately determined and the accuracy degradation of the learning model can be minimized.

The learning system S repeatedly executes the learning process until the parameters of all the layers of the learning model are quantized, thereby quantizing the parameters of all the layers to compress the amount of information and further reducing the data size of the learning model.

Further, the learning system S can effectively prevent the accuracy degradation of the learning model by quantizing the layers of the learning model one by one so as to gradually quantize the layers. In other words, if the layers are quantized at once, the accuracy of the learning model may decrease at once for the reason described above, but if the layers are quantized one by one, it is possible to prevent the accuracy of the learning model from decreasing at once and to minimize the accuracy degradation of the learning model.

In addition, the learning system S selects layers to be quantized from the learning model one after another in the predetermined order, thereby quantizing the layers in an order according to the intent of the creator of the learning model. For example, if the creator of the learning model has found the order by which the accuracy degradation can be prevented, it is possible to create the learning model that can minimize the accuracy degradation by selecting the layers to be quantized based on the order specified by the creator.

The learning system S randomly selects the layers to be quantized one after another from the learning model. It is thus possible for the creator of the learning model to execute the learning process without specifying a particular order of the layers.

Further, the learning system S repeats the learning process a predetermined number of times by quantizing the parameter of a part of the layers, and then repeats the learning process a predetermined number of times by quantizing the parameters of the other layers. This can set the quantized parameters to more accurate values and effectively prevent the accuracy degradation of the learning model.

Further, the learning system S quantizes the weighting factor of a part of the layers and executes the learning process, and then quantizes the weighting factors of the other layers and executes the learning process, thereby reducing the data size of the learning model while preventing the accuracy degradation of the learning model. For example, the data size of the learning model can be further reduced by quantizing a weighting factor, which has the amount of information that tends to increase due to the floating-point number.

Further, the learning system S binarizes the parameter of a part of the layers of the learning model and executes the learning process, and then binarizes the parameters of the other layers of the learning model and executes the learning process. In this manner, the learning system S can reduce the data size of the learning model by utilizing the binarization effective for compressing the data size.

### [5. Variations]

The one or more embodiments of the present invention is not to be limited to the above described embodiment. The one or more embodiments of the present invention can be changed as appropriate without departing from the spirit of the invention.

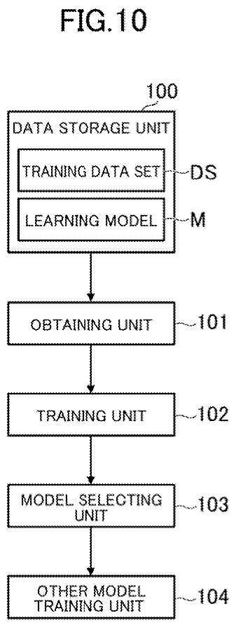

FIG. 10 is a functional block diagram of a variation. As shown in FIG. 10, in the variation to be described below, a model selecting unit 103 and an other model training unit 104 are implemented in addition to the functions described in the embodiment.

(1) For example, as described in the embodiment, the accuracy of the learning model may differ depending on the order in which the layers to be quantized are selected. For this reason, in a case where it is not known in which order the layers can be quantized with the highest accuracy, a plurality of learning models may be created based on a plurality of orders so as to select the learning model having a relatively high accuracy in the end.

The training unit 102 according to the present variation selects layers to be quantized one after another based on each of a plurality of orders, and creates a plurality of learning models. Here, the plurality of orders may be all of the permutation combinations of the L layers, or only some of the combinations of the L layers. For example, if the number of layers is about 5, the learning model may be created in all of the combinations, but if the number of layers is 10 or more, the total number of permutation combinations increases, and thus a learning model may be created only for some of the orders. The plurality of orders may be specified in advance or may be randomly generated.

The training unit 102 quantizes the layers one after another in each order to create a learning model. The method of creating each learning model are as described in the embodiment. In this variation, the number of orders matches the number of learning models to be created. That is, the order and the learning model correspond one-to-one. For example, if there are m orders (m: a natural number equal to or greater than 2), the training unit 102 creates m learning models.

The learning system S of this variation includes the model selecting unit 103. The model selecting unit 103 is mainly implemented by the control unit 11. The model selecting unit 103 selects at least one of the plurality of learning models based on the accuracy of each learning model.

The accuracy of the learned models may be evaluated by a known method, and in this variation, an error rate (incorrect answer rate) with respect to the training data is used. The error rate is opposite to the correct answer rate, and a rate at which the output from the learning model and the output (correct answer) shown in the training data does not match when all of the training data used in the learning process is entered in the trained learning model. The lower the error rate, the higher the accuracy of the learning model.

The model selecting unit selects a learning model having relatively high accuracy among the plurality of learning models. The model selecting unit may select only one learning model, or a plurality of learning models. For example, the model selecting unit selects a learning model having the highest accuracy among the plurality of learning models. The model selecting unit may select a learning model having the second or third highest accuracy instead of the learning model having the highest accuracy. As another example, the model selecting unit may select one of the learning models having the accuracy equal to or higher than a threshold value from the plurality of learning models.

According to the variation (1), a plurality of learning models are created by selecting layers to be quantized one after another based on each of a plurality of orders, and at least one of the plurality of learning models is selected based on the accuracy of each learning model. This serves to effectively prevent the accuracy degradation of the learning model.

(2) Further, for example, in the variation (1), the order of the learning model having relatively high accuracy may be used for training the other learning models. In this case, it is possible to create a learning model having high accuracy without attempting a plurality of orders at the time of training the other learning models.

The learning system S of this variation includes the other model training unit 104. The other model training unit 104 is mainly implemented by the control unit 11. The other model training unit 104 executes a learning process of other learning models based on the order corresponding to the learning model selected by the model selecting unit 103. The order corresponding to the learning model is the selection order of the layers used when the learning model is created. The other learning models are different models than the trained learning model. The other learning models may use the same training data as the trained learning model, or may use another training data.

The other learning models may be trained in the same flow as the trained learning model. That is, the other model training unit 104 repeatedly executes a learning process of the other learning models based on the training data. The other model training unit 104 quantizes the layers of the other learning models one after another in the order corresponding to the learning model selected by the model selecting unit 103, and executes the learning process. The individual learning processes are as described with regard to the training unit 102 in the embodiment.

According to the variation (2), the learning process of the other learning models are executed based on the order corresponding to the learning model having relatively high accuracy, and the learning process of the other learning models can be thereby efficiently executed. For example, when creating other learning models, a learning model with high accuracy can be created without testing a plurality of orders. This can reduce the processing load of the learning device 10 and quickly create a highly accurate learning model.

(3) Further, for example, the above variations may be combined.

For example, the case has been described in which the parameters of all the layers of the learning model are quantized, although there may be a layer that is not to be quantized in the learning model. That is, a layer in which a parameter is represented by a floating-point number and a quantized layer may be mixed. For example, the case has been described in which the layers of the learning model are quantized one by one, although the layers may be quantized in groups. For example, the two or three layers of learning model may be quantized at a time. Further, for example, not a weighting factor but other parameters, such as bias, may also be quantized. Further, for example, the quantization is not limited to binarization, but it is sufficient if the quantization can reduce amount of information (the number of bits) of the parameters.

Further, for example, the learning system S may include a plurality of computers, and functions may be shared by the computers. For example, the selecting unit 101 and the training unit 102 may be implemented by a first computer, and the model selecting unit 103 and the other model training unit 104 may be implemented by a second computer. For example, the data storage unit 100 may be implemented by a database server outside the learning system S.

1. A learning system comprising at least one processor configured to:
obtain training data to be learned by a learning model; and
repeatedly execute a learning process of the learning model based on the training data, wherein
the at least one processor quantizes a parameter of a part of layers of the learning model and executes the learning process, and then quantizes parameters of other layers of the learning model and executes the learning process,
the at least one processor selects layers to be quantized one after another based on each of a plurality of orders and creates a plurality of learning models, and
the at least one processor selects at least one of the plurality of learning models based on accuracy of each learning model.

2. The learning system according to claim 1, wherein the at least one processor repeatedly executes the learning process until parameters of all of the layers of the learning model are quantized.

3. The learning system according to claim 1, wherein the at least one processor quantizes the layers of the learning models one by one.

4. The learning system according to claim 1, wherein
the at least one processor selects layers to be quantized one after another in a predetermined order from the learning model.

5. The learning system according to claim 1, wherein
the at least one processor randomly selects layers to be quantized one after another from the learning model.

6. The learning system according to claim 1, wherein
the at least one processor quantizes the parameter of the part of the layers and repeats the learning process a predetermined number of times, and then quantizes the parameters of the other layers and repeats the learning process a predetermined number of times.

7. (canceled)

8. The learning system according to claim 1, wherein the at least one processor executes a learning process of other learning models based on an order corresponding to the selected learning model selected by the selecting means.

9. The learning system according to claim 1, wherein
a parameter of each layer includes a weighting factor, and
the at least one processor quantizes a weighting factor of the part of the layers and executes the learning process, and then quantizes weighting factors of other layers and executes the learning process.

10. The learning system according to claim 1, wherein
the at least one processor binarizes a parameter of a part of the learning model and executes the learning process, and then binarizes parameters of other layers of the learning model and executes the learning process.

11. A learning method comprising:
obtaining training data to be learned by a learning model;
repeatedly executing a learning process of the learning model based on the training data,
quantizing a parameter of a part of layers of the learning model and executes the learning process, and then quantizes parameters of other layers of the learning model and executes the learning process,
selecting layers to be quantized one after another based on each of a plurality of orders and creates a plurality of learning models, and
selecting at least one of the plurality of learning models based on accuracy of each learning model.

12. A non-transitory computer-readable information storage medium for storing a program for causing a computer to:
obtain training data to be learned by a learning model;
repeatedly execute a learning process of the learning model based on the training data,
quantize a parameter of a part of layers of the learning model and executes the learning process, and then quantizes parameters of other layers of the learning model and executes the learning process,
select layers to be quantized one after another based on each of a plurality of orders and creates a plurality of learning models, and
select at least one of the plurality of learning models based on accuracy of each learning model.
